(19) United States
(12) Patent Application Publication
(10) Pub. No.: US 2023/0191641 A1
(43) Pub. Date: Jun. 22, 2023

(54) SHEET PROCESSING APPARATUS HAVING PUNCHING UNIT FOR PUNCHING SHEETS AND IMAGE FORMING APPARATUS

(71) Applicant: CANON KABUSHIKI KAISHA, Tokyo (JP)

(72) Inventor: Takahiro ENDO, Shizuoka (JP)

(21) Appl. No.: 18/059,038

(22) Filed: Nov. 28, 2022

(30) Foreign Application Priority Data
Dec. 17, 2021 (JP) 2021-205469

(51) Int. Cl. B26D 5/28; B65H 35/00; B65H 35/08

(52) U.S. Cl. CPC B26D 5/28; B65H 35/0086; B65H 35/08

(57) ABSTRACT

A sheet processing apparatus includes: a punching unit configured to punch a sheet conveyed; a movement unit configured to cause the punching unit to move in a direction intersecting with a conveyance direction of the sheet; a detection unit configured to detect a first conveyance position which is a position in a width direction orthogonal to the conveyance direction of the sheet; and a control unit configured to obtain size information of the sheet, determine, based on the size information, a second conveyance position in the width direction when the sheet is conveyed, and by comparing the first conveyance position and the second conveyance position, control whether or not to execute an avoidance process that causes the punching unit to move away from the sheet.

### BACKGROUND OF THE INVENTION

### Field of the Invention

The present disclosure relates to a sheet processing apparatus for punching a sheet, and an image forming apparatus including the sheet processing apparatus.

### Description of the Related Art

A sheet processing apparatuses that perform various processes on a sheet on which an image is formed by an image forming apparatus such as a copying machine or a printer have been employed. One of the processes performed by a sheet processing apparatus is a sheet punching process. Holes punched on the sheet by the punching process may be used for filing the sheet or the like. For the punching process, there are a method in which a plurality of sheets are sequentially stacked and then collectively punched, and a method in which sheets are punched one sheet at a time while being conveyed.

For the method of collectively punching, it is necessary to provide a mechanism for stacking and holding a plurality of sheets and a mechanism for aligning the plurality of held sheets, which increases the size of the sheet processing apparatus. In addition, the processing speed may be reduced due to an alignment operation. On the other hand, for the method of punching one sheet at a time, a mechanism for stacking and holding a plurality of sheets and a mechanism for aligning the plurality of sheets are not required, and the apparatus can be miniaturized and a decrease in the processing speed can be suppressed.

US-2021-107759 discloses a sheet processing apparatus that punches sheets one sheet at a time while conveying the sheets. According to US-2021-107759, a punching unit for punching a sheet in the sheet processing apparatus is configured to be movable in an intersecting direction that intersects the conveyance direction of the sheet. Also, the sheet processing apparatus includes a detection unit that detects an end portion position of the sheet in a width direction orthogonal to the conveyance direction of the sheet. By adjusting the position of the punching unit based on a detection result by a detection unit, the punching can be performed with good accuracy with respect to the target position of the punching.

According to US-2021-107759, prior to a sheet being conveyed to the punching position by the punching unit, the sheet processing apparatus moves the punching unit to a predetermined position corresponding to the size of the sheet in advance. Here, in a case where the sheet is conveyed having largely deviated in the width direction, a contact occurs between the punching unit standing by at the predetermined position and the sheet. Also, even in a case where the size of the sheet that has been set as the target of conveyance and the size of the sheet that has actually been conveyed are significantly different from each other, a contact between the punching unit and the sheet occurs. When the sheet comes into contact with the punching unit, conveyance of the sheet may be stopped.

### SUMMARY OF THE INVENTION

According to an aspect of the present disclosure, a sheet processing apparatus includes: a conveyance unit configured to convey a sheet along a conveyance path; a punching unit configured to punch the sheet conveyed by the conveyance unit; a movement unit configured to cause the punching unit to move in a direction intersecting with a conveyance direction of the sheet; a detection unit arranged on an upstream side of the conveyance path with reference to the punching unit, and configured to detect a first conveyance position which is a position in a width direction orthogonal to the conveyance direction of the sheet conveyed by the conveyance unit; and a control unit configured to obtain size information of the sheet, determine, based on the size information, a second conveyance position which is a position in the width direction when the sheet is conveyed by the conveyance unit, and by comparing the first conveyance position and the second conveyance position, control whether or not to execute an avoidance process that causes the punching unit to move away from the sheet.

Further features of the present invention will become apparent from the following description of exemplary embodiments with reference to the attached drawings.

### BRIEF DESCRIPTION OF THE DRAWINGS

FIG. 1 is a configuration diagram of an image forming apparatus according to an embodiment.

FIGS. 2A to 2D are configuration diagrams of a punching unit according to an embodiment.

FIGS. 3A and 3B are configuration diagrams of a moving module of the punching unit according to an embodiment.

FIG. 4 is a view illustrating a control configuration of the image forming apparatus according to an embodiment.

FIG. 5 is a functional block diagram relating to control of the image forming apparatus according to an embodiment.

FIGS. 6A to 6D are views for describing an operation of a sheet processing apparatus according to an embodiment.

FIGS. 7A to 7C are views for describing an operation of the sheet processing apparatus according to an embodiment.

FIG. 8 is a flowchart of processing executed by a main control unit according to an embodiment.

FIG. 9 is a view for describing a specific operation of the sheet processing apparatus according to an embodiment.

FIG. 10 is a functional block diagram relating to control of the image forming apparatus according to an embodiment.

FIG. 11 is a view illustrating an example of information used by a width estimation unit to estimate a sheet width according to an embodiment.

FIGS. 12A to 12D are views for describing an operation of a sheet processing apparatus according to an embodiment.

FIGS. 13A to 13C are views for describing an operation of the sheet processing apparatus according to an embodiment.

FIG. 14 is a flowchart of processing executed by the main control unit according to an embodiment.

FIG. 15 is a view for describing a specific operation of the sheet processing apparatus according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

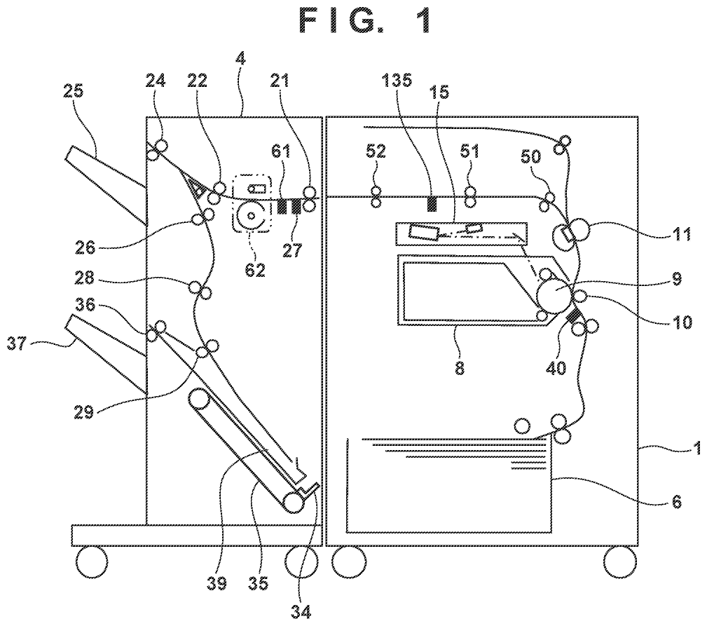

FIG. 1 is a cross-sectional view of an image forming apparatus 1 including a sheet processing apparatus 4 according to the present embodiment. Note that FIG. 1 can also be regarded as an image forming system including the sheet processing apparatus 4 and the image forming apparatus 1. The image forming apparatus 1 includes a cartridge 8 that has a photoconductor 9. At the time of image formation, the photoconductor 9 is rotationally driven, and is charged to a predetermined potential by a charging unit in the cartridge 8. An exposure unit 15 forms an electrostatic latent image on the photoconductor 9 by exposing the charged photoconductor 9. A developing unit in the cartridge 8 develops the electrostatic latent image of the photoconductor 9 with toner to form a toner image on the photoconductor 9.

Meanwhile, by rollers provided along a conveyance path, a sheet stored in a cassette 6 is fed to the conveyance path, and conveyed along the conveyance path. Note, in the present embodiment, sheets are conveyed such that a center position in a width direction parallel to the sheet surface and orthogonal to the conveyance direction of the sheet coincides with a predetermined position in the width direction of the conveyance path. In a case where the center position in the width direction of the sheet coincides with the predetermined position in the width direction of the conveyance path, the position of one reference end portion among two end portions in the width direction of the conveyed sheet is determined according to the length of the sheet in the width direction (hereinafter referred to as the sheet width). In the following description, the position in the width direction of the reference end portion corresponding to the sheet is referred to as a reference conveyance position. The reference conveyance position varies depending on the sheet width. Note, in this example, the predetermined position in the width direction of the conveyance path is defined as a center position in the width direction of the conveyance path.

Returning to FIG. 1, the sheet that has been fed into the conveyance path is conveyed toward a nip region between the photoconductor 9 and a transfer roller 10 by a roller provided along the conveyance path. The transfer roller 10 transfers the toner image of the photoconductor 9 to the sheet by outputting a transfer bias voltage. As described above, the cartridge 8 is an image forming unit that forms a toner image on the sheet by transferring the toner image formed on the photoconductor 9 to the sheet. Further, the cartridge 8 and the exposure unit 15 can be regarded as an image forming unit that forms a toner image on the sheet.

A registration sensor 40 for detecting a sheet is provided upstream of the nip region between the photoconductor 9 and the transfer roller 10 in the sheet conveyance direction. The detection result of the sheet by the registration sensor 40 is used to control the timing of feeding the sheet to the nip region between the photoconductor 9 and the transfer roller 10 and the like. A fixing unit 11 fixes the toner image on the sheet by heating and pressurizing the sheet to which the toner image has been transferred. The sheet that has passed through the fixing unit 11 is conveyed toward the sheet processing apparatus 4 by the conveyance rollers 50, 51, and 52. Note, a conveyance sensor 135 for detecting a sheet is provided between the conveyance roller 51 and the conveyance roller 52. The sheet conveyed to the sheet processing apparatus 4 is conveyed by an entrance roller 21 and an exit roller 22.

Between the entrance roller 21 and the exit roller 22, an entrance sensor 27 for detecting the presence or absence of the sheet, a line sensor 61 for detecting the conveyance position of the sheet in the width direction, and a punching unit 62 for punching the sheet are provided along the conveyance direction of the sheet. The detection result of the entrance sensor 27 is used to determine the timing at which the line sensor 61 detects the sheet, or the like. The line sensor 61 is an image sensor in which a light source, a light receiving element, and a lens are arranged in an array, and the line sensor 61 is arranged such that the reference end portion of the sheet passes between the light source and the light receiving element. Note, as described above, the reference end portion is an end portion of the sheet corresponding to the reference conveyance position. The line sensor 61 detects the position of the reference end portion in the width direction of the sheet as the conveyance position in the width direction of the sheet based on the amount of light received by the light receiving element. Note, in the following description, the “conveyance position” means a position in the width direction unless otherwise specified.

The punching unit 62 is configured to be movable in the width direction. By moving the punching unit 62 in the width direction in accordance with the conveyance position of the sheet detected by the line sensor 61, the target position of the punching on the sheet can be accurately punched by the punching unit 62. The sheet, after having passed through the punching unit 62, is discharged to a tray 25 by a discharge roller 24. Note, the sheet processing apparatus 4 includes a tray 37 in addition to the tray 25 as a discharge destination of the sheet. In a case where the discharge destination of the sheet is the tray 37, the rotation of the discharge roller 24 is stopped immediately before the sheet is discharged to the tray 25, and thereafter, the sheet is rotationally driven in a direction opposite the previous direction. By the reverse rotation of the discharge roller 24, the sheet is conveyed to an intermediate stacking unit 39 by the roller 26, the roller 28, and the roller 29. One or more sheets are stacked on the intermediate stacking unit 39, and a binding process is performed by a stapler (not shown) as necessary. Thereafter, one or more sheets on the intermediate stacking unit 39 are pushed out by a discharge guide 34 connected to a guide driving unit 35, and are discharged to the tray 37 by a discharge roller 36.

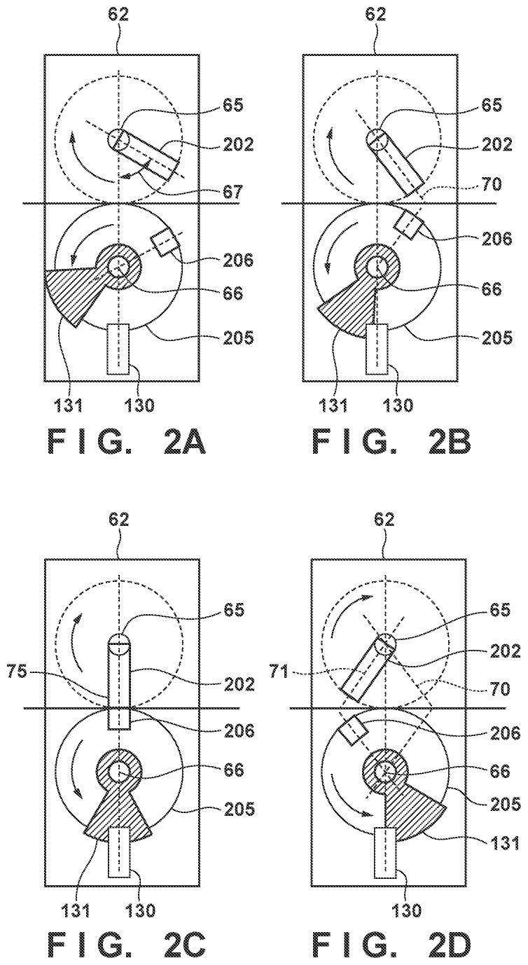

FIGS. 2A to 2D are configuration diagrams of the punching unit 62. A punch 202 is configured to be rotatable about an axis 65. A die 205 is configured to be rotatable about an axis 66. Note that the punch 202 is rotationally driven in the clockwise direction of FIGS. 2A to 2D, and the die 205 is rotationally driven in the counterclockwise direction of FIGS. 2A to 2D in synchronization with the punch 202. The die 205 is provided with a die hole 206 at a position corresponding to the punch 202. Further, the die 205 is provided with a fan-shaped sensor flag 131. The sensor flag 131 is provided so as to cross the optical path from the light emitting element to the light receiving element of a photo interrupter 130 in accordance with the rotation phase of the die 205. The photo interrupter 130 detects the sensor flag 131 based on the amount of light received by the light receiving element.

FIG. 2A shows that the rotational phase (rotational position) of the punch 202 is a standby phase. The standby phase is a state in which an angle 67 with a punching phase 75, in which the punch 202 can punch the sheet (refer to FIG. 2C), is a predetermined value, and the punch 202 is controlled to wait in the standby phase until the sheet to be punched is conveyed. Note that the standby phase of the punch 202 is set so as not to hinder the conveyance of the sheet. FIG. 2B shows that the rotational phase of the punch 202 is a start phase 70 in which a punch into the sheet will start. FIG. 2C shows that the rotational phase of the punch 202 is the punching phase 75. In this state, the punch 202 and the die hole 206 are engaged, and the sheet can be punched by the punch 202. FIG. 2D shows that the rotational phase of the punch 202 is an end phase 71.

The photo interrupter 130 is configured such that it is in a light shielding state by the sensor flag 131 in a range from the start phase 70 to the end phase 71, and is in a light transparent state in other ranges. The rotation phase of the punch 202 is detected by monitoring the timing of the change of the state of the photo interrupter 130 while the die 205 is rotated. For example, the timing at which the state of the photo interrupter 130 changes from the light transparent state to the light shielding state is the timing at which the rotation phase of the punch 202 enters the start phase 70. By stopping the rotation of the punch 202 at a predetermined timing with reference to this timing, the punch 202 can be stopped at the punching phase 75.

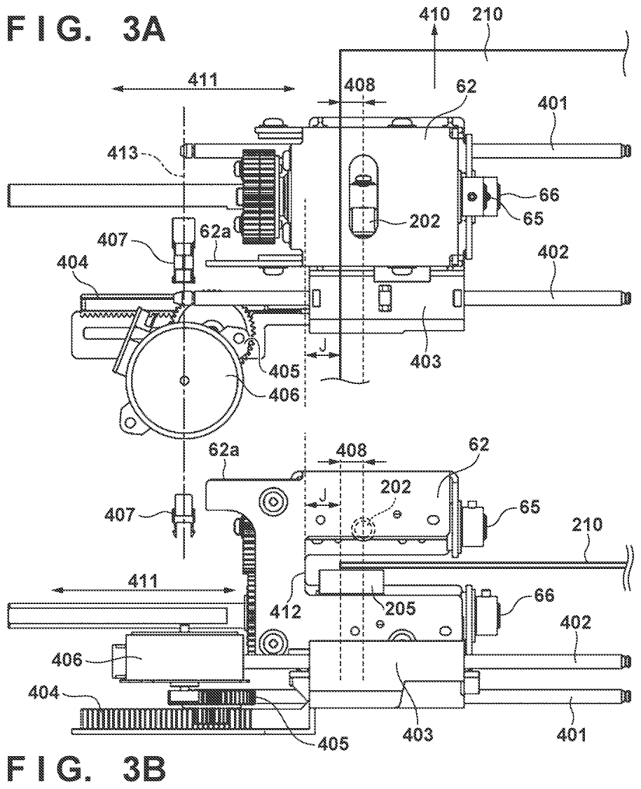

Next, a moving module for moving the punching unit 62 in the width direction is described. FIG. 3A is a plan view in which the moving module is viewed from the upper side of the sheet processing apparatus, and FIG. 3B is a side view when the moving module is viewed in the conveyance direction. In FIGS. 3A and 3B, reference numeral 210 denotes a sheet, and reference numeral 410 denotes a conveyance direction of the sheet. In FIGS. 3A and 3B, the punching unit 62 is configured to be movable in a width direction 411.

The punching unit 62 is supported by a base unit 403. The base unit 403 is movably supported by guide shafts 401 and 402 extending in the width direction 411. The base unit 403 has a rack gear 404 extending in the width direction 411. The moving module includes a shift motor 406 and an idler gear 405 which is rotationally driven by the shift motor 406. The idler gear 405 meshes with the rack gear 404. The shift motor 406 is, for example, a stepping motor. By driving the shift motor 406, the punching unit 62 supported by the base unit 403 moves along the guide shafts 401 and 402 in the width direction 411.

Also, the moving module includes a home position sensor 407. The home position sensor 407 is, for example, a photo interrupter, and detects a detection target part 62a provided in the punching unit 62. Reference numeral 413 in FIG. 3A indicates a position at which the detection state of the detection target part 62a by the home position sensor 407 is changed. In the present embodiment, in a case where the punching process is not performed, the punching unit 62 stands by when the detection target part 62a reaches the position 413. In the following description, this position at which the punching unit 62 stands by is referred to as a home position. The home position is set such that the punching unit 62 waiting there does not interfere with a conveyed sheet. The position of the punching unit 62 in the width direction is managed by a number of pulses inputted into the shift motor 406 with reference to the home position.

The punching unit 62 is configured to allow the sheet 210 to pass between the punch 202 and the die 205. In the present example, as shown in FIG. 3B, the punching unit 62 is provided with an opening through which the sheet passes. The opening has a U-shape when viewed in the conveyance direction. The position at which the punching unit 62 punches the sheet is a position on the sheet 210 that is separated in the width direction by a predetermined distance 408 from the end portion of the left end (reference end portion) of the sheet 210 in the conveyance direction. Hereinafter, this position is referred to as a punching target position. When a punch will be performed, the position in the width direction is adjusted such that the punching unit 62 will punch the punching target position. In a case where the position of the punching unit 62 in the width direction is a position where the punching target position can be punched, the distance between the left end of the sheet 210 and an end portion 412 in the width direction of the opening of the punching unit 62 is J. In a case where the sheet is conveyed with the reference end portion of the sheet 210 deviating by J or more to the left in a case where the punching unit 62 is positioned at the position in FIG. 3B, the sheet 210 and the punching unit 62 interfere with each other, and the conveyance of the sheet is hindered thereby.

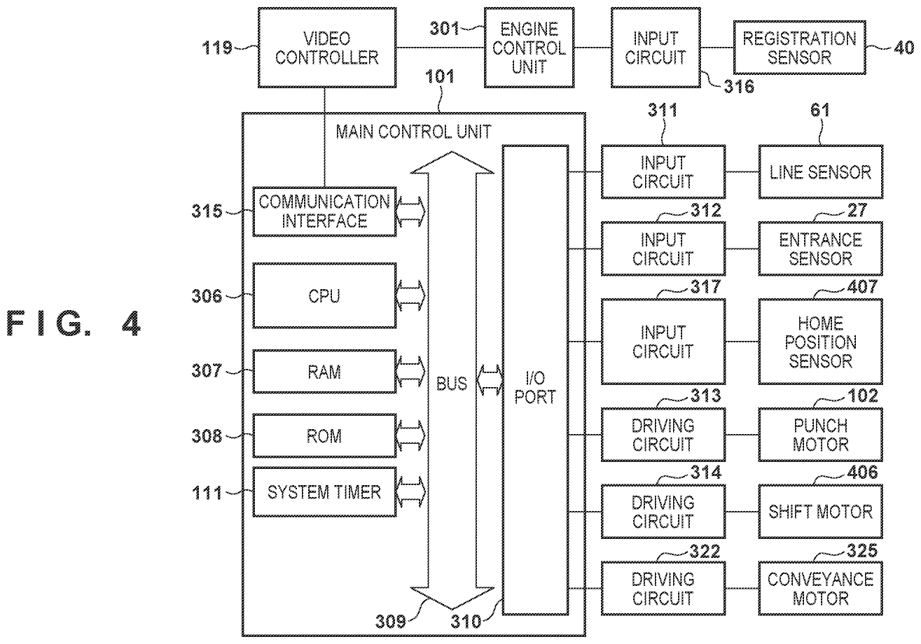

FIG. 4 is a block diagram illustrating a hardware configuration of the image forming apparatus 1. Note that FIG. 4 basically shows units necessary for the description of the present embodiment in the hardware configuration of the image forming apparatus 1. The video controller 119 is responsible for overall control of the entire image forming apparatus 1. An engine control unit 301 controls image formation onto a sheet. For example, the engine control unit 301 controls the conveyance unit to feed the sheet stored in the cassette 6 to the conveyance path, and conveys the sheet to the sheet processing apparatus 4. Note, the conveyance unit includes rollers provided along the conveyance path and a motor for rotating the rollers. Further, the engine control unit 301 controls the cartridge 8 and the exposure unit 15 to form a toner image on the photoconductor 9, and causes the toner image of the photoconductor 9 to be transferred onto the sheet conveyed by the conveyance unit. Further, the engine control unit 301 controls the fixing unit 11 to fix the toner image on the sheet. Also, a detection result of a sheet by the registration sensor 40 is inputted to the engine control unit 301 via an input circuit 316.

A main control unit 101 controls the sheet processing apparatus 4. A CPU 306 of the main control unit 101 is a central processing unit that controls various operations of the sheet processing apparatus 4. A RAM 307 is a volatile memory that temporarily stores control data required for the operation of the sheet processing apparatus 4. A ROM 308 is a non-volatile memory that stores programs or a control table necessary for the operation of the sheet processing apparatus 4. A system timer 111 generates timings necessary for various kinds of control in the sheet processing apparatus 4. A communication interface 315 communicates with the video controller 119. The above-described constituent elements of the main control unit 101 and an I/O port 310 described below are configured to be able to communicate with each other via a bus 309. The I/O port 310 provides an input/output interface between various units of the sheet processing apparatus 4. Specifically, a detection result of the conveyance position of the sheet by the line sensor 61, a detection result of the sheet by the entrance sensor 27, and a detection result of the detection target part 62a by the home position sensor 407 are inputted to the I/O port 310 through input circuits 311, 312, and 317. In addition, the I/O port 310 outputs drive signals to a punch motor 102, the shift motor 406, and a conveyance motor 325 via driving circuits 313, 314, and 322. Note that the punch motor 102 is a motor that rotationally drives the punch 202 and the die 205. The conveyance motor 325 is a motor that drives a plurality of rollers that convey sheets in the sheet processing apparatus 4. Note, the conveyance motor 325 and the plurality of rollers constitute a sheet conveyance unit.

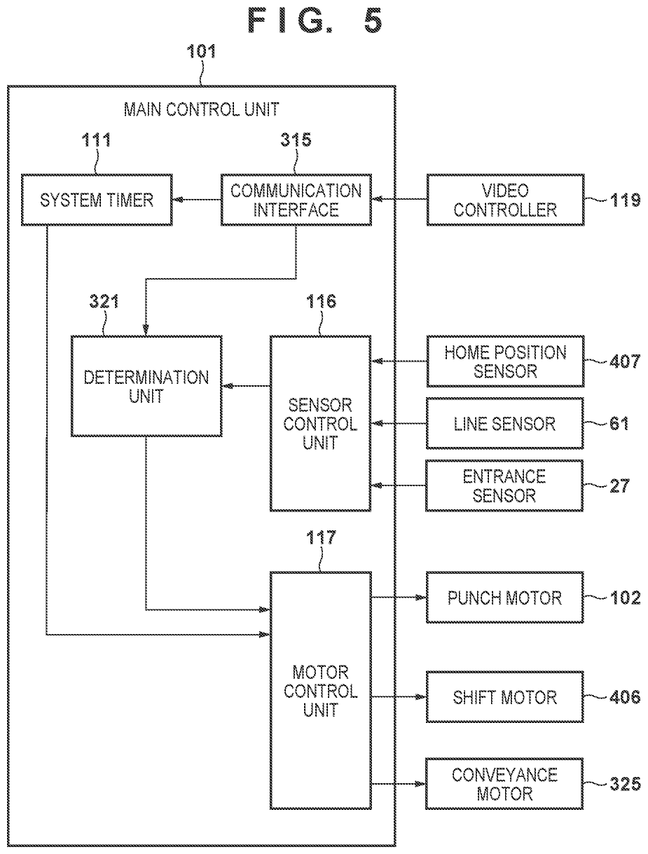

FIG. 5 is a functional block diagram illustrating a control configuration of the image forming apparatus 1 according to the present embodiment. Note that FIG. 5 only illustrates units related to the punching control on a sheet, and omits other units. Signals from the entrance sensor 27, the line sensor 61, and the home position sensor 407 are inputted to the sensor control unit 116. The communication interface 315 receives print information related to printing from the video controller 119. The print information includes information indicating whether or not punching will be performed on the sheet. In a case where punching will be performed, the print information includes punch information such as a punch interval and the number of punches in the conveyance direction, and size information indicating the size of the sheet to be punched. Note that the size information includes information for indicating or determining the length of the sheet in the width direction (hereinafter referred to as the sheet width) and the length of the sheet in the conveyance direction (hereinafter referred to as the sheet length). The contents of this print information are based on information set by a user via an operation unit (not shown) of the image forming apparatus 1 when the user performs image formation on a sheet. Alternatively, the contents of this print information are based on information included in a print job received by the image forming apparatus 1 from a host computer, which is an external apparatus, when the user performs image formation on a sheet. Note, the information included in the print job is based on information set by the user in the host computer.

The system timer 111 generates various timings related to sheet conveyance, movement of the punching unit 62, and the like based on print information from the video controller 119. A motor control unit 117 drives and controls the punch motor 102, the shift motor 406, and the conveyance motor 325 based on various timings generated by the system timer 111. A determination unit 321 determines the reference conveyance position of the sheet based on the sheet width indicated by size information obtained by the communication interface 315 or determined based on the size information. The determination unit 321 compares the determined reference conveyance position with the conveyance position of the sheet detected by the line sensor 61 to determine whether or not an avoidance process of the punching unit 62 is necessary. The avoidance process is a process of moving the punching unit 62 away from the sheet, or more specifically, causing the punching unit 62 to move toward the home position, so that the punching unit 62 does not interfere with the sheet. In a case where it is determined that the avoidance process is necessary, the determination unit 321 instructs the motor control unit 117 to execute the avoidance process. Upon receiving an instruction to execute the avoidance process from the determination unit 321, the motor control unit 117 outputs a drive signal to the shift motor 406 to perform the avoidance process of the punching unit 62.

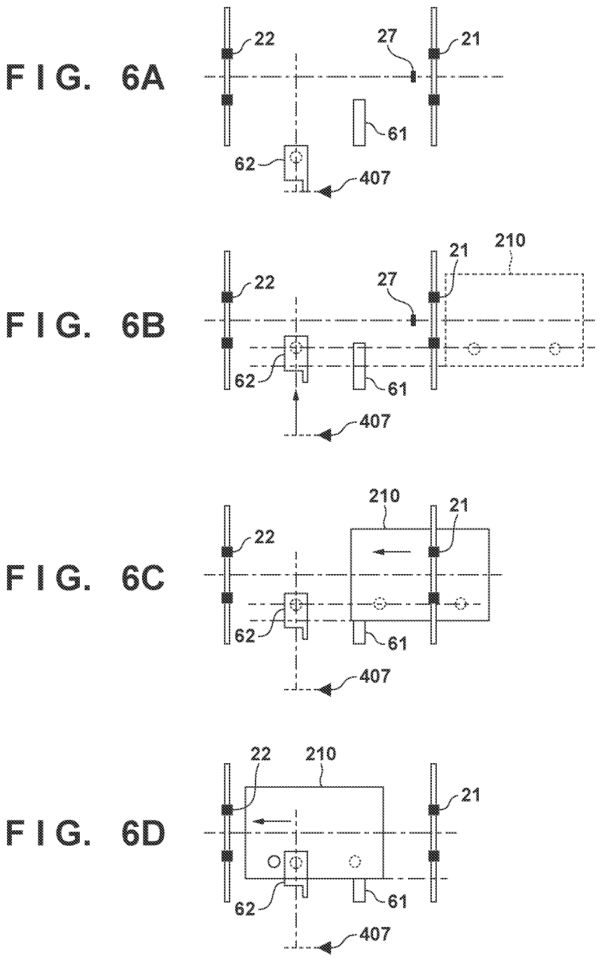

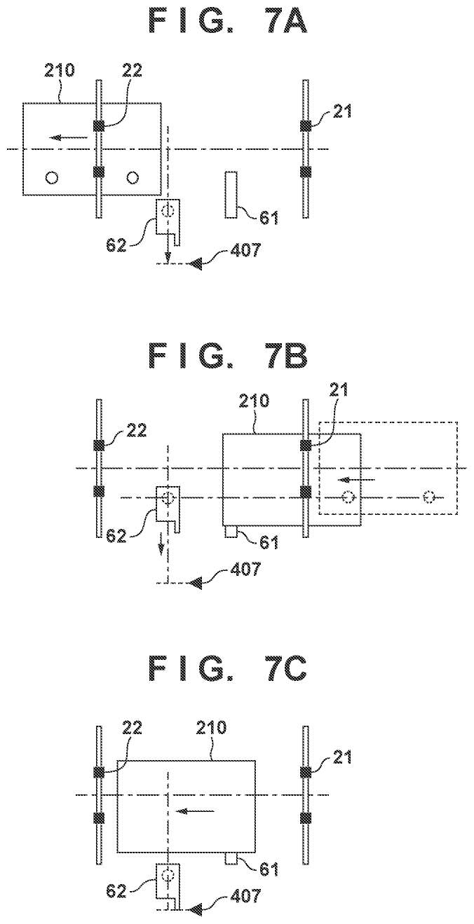

Processes performed by the main control unit 101 are described with reference to FIGS. 6A to 6D and FIGS. 7A to 7C. FIG. 6A shows an initial state before a sheet is conveyed, and the main control unit 101 causes the punching unit 62 to stand by at the home position. FIG. 6B shows a state before the sheet 210 reaches the entrance roller 21, and the determination unit 321 causes the punching unit 62 to move to a reference standby position based on the reference conveyance position of the sheet 210. Note, the determination unit 321 determines the reference conveyance position based on the size information obtained from the video controller 119. The reference standby position is, for example, a position at which the end portion 412 of the punching unit 62 illustrated in FIG. 3B becomes separated from the reference conveyance position of the sheet by a distance J. Note that although the sheet 210 is illustrated in FIG. 6B to show the relationship between the conveyance position of the sheet 210 and the reference standby position, the sheet 210 is not in the position shown in the figure, but is actually more upstream of the conveyance path. Therefore, in FIG. 6B, the sheet 210 is indicated by a dashed line. Note that, in FIG. 6B, the dashed circles of the sheet 210 indicate punching target positions. FIG. 6C shows a state in which the sheet 210 has reached the detection position of the line sensor 61. In FIG. 6C, the conveyance position detected by the line sensor 61 is substantially the same as the reference conveyance position. The determination unit 321 determines that the avoidance process is necessary when the difference between the conveyance position and the reference conveyance position is larger than a first threshold value, and determines that the avoidance process is unnecessary when the difference is equal to or smaller than the first threshold value. In this example, since the difference between the conveyance position and the reference conveyance position is equal to or smaller than the first threshold value, the determination unit 321 determines that the avoidance process is unnecessary.

FIG. 6D shows a state in which the leading end portion of the sheet 210 passes through the punching unit 62, and the punching unit 62 has formed one hole in the sheet 210. The solid circle of the sheet 210 indicates where a hole has been punched. FIG. 7A shows a state in which the sheet 210 has passed through the punching unit 62. When the punching of the sheet 210 has completed, the main control unit 101 causes the punching unit 62 to move toward the home position. In this manner, in a case where a skew amount of the sheet 210 is small and the sheet 210 is conveyed at approximately the reference conveyance position, a normal punching process is performed.

On the other hand, FIG. 7B shows a case where the sheet 210 is conveyed at a position that largely deviates from the reference conveyance position in the width direction. Note that the dashed rectangle in FIG. 7B indicates a sheet in a case where the sheet has been conveyed at the reference conveyance position. The reason why the conveyance position of the sheet 210 is shifted more in the width direction than the reference conveyance position is, for example, that the sheet 210 had not been disposed at the correct position in the cassette 6, that the cassette 6 itself had not been correctly attached to the image forming apparatus 1, or the like. When the difference between the conveyance position detected by the line sensor 61 and the reference conveyance position is larger than the first threshold value, the determination unit 321 determines that the punching unit 62 will interfere with the sheet 210 and executes the avoidance process. In this example, the determination unit 321 determines that the avoidance process is necessary, and instructs the motor control unit 117 to execute the avoidance process. When the avoidance process is instructed, the motor control unit 117 drives the shift motor 406 to cause the punching unit 62 to move toward the home position, that is, to cause the punching unit 62 to move away from the sheet, as shown in FIG. 7B. FIG. 7C shows a state in which the punching unit 62 is retracted to the home position by the avoidance process. As shown in FIG. 7C, the punching unit 62 does not interfere with the sheet 210, and the sheet 210 is conveyed as it is.

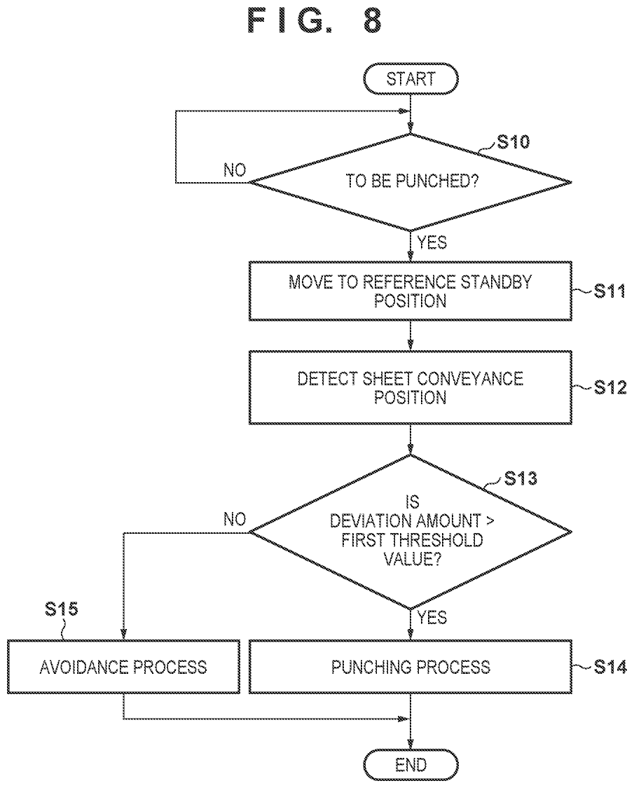

FIG. 8 is a flowchart of processing executed by the main control unit 101 including the determination unit 321. Note that at the start of the processing of FIG. 8, the punching unit 62 is standing by at the home position. When the sheet is conveyed, the main control unit 101 determines whether or not the sheet is to be punched based on the print information obtained from the video controller 119 in step S10. If the sheet is not to be punched, the main control unit 101 repeats the processing from step S10. On the other hand, when the sheet is to be punched, the main control unit 101 moves the punching unit 62 to the reference standby position in step S11. Note, the reference standby position is a position based on the reference conveyance position of the conveyed sheet. Further, the reference conveyance position of the sheet is determined based on the size information included in the print information obtained from the video controller 119, more specifically, the sheet width of the conveyed sheet. The main control unit 101 determines the conveyance position of the sheet from the detection result by the line sensor 61 in step S12. Note that the timing of detection of the sheet by the line sensor 61 is determined based on the timing at which the entrance sensor 27 detects the sheet.

In step S13, the main control unit 101 obtains the difference between the reference conveyance position of the sheet and the conveyance position of the sheet detected by the line sensor 61 as the deviation amount in the width direction of the conveyance position, and compares the deviation amount with the first threshold value. In a case where the deviation amount is greater than the first threshold value, the main control unit 101 in step S15 performs the avoidance process described above, otherwise, the main control unit 101 executes the punching process by the punching unit 62 in step S14. Note that configuration may be taken such that the avoidance process is executed in a case where the amount of deviation is larger than the first threshold value and the conveyance position of the sheet detected by the line sensor 61 is closer to the punching unit 62 than the reference conveyance position. This is because even if the amount of deviation is larger than the first threshold value, in a case where the conveyance position of the sheet detected by the line sensor 61 is farther from the punching unit 62 than the reference conveyance position, the punching unit 62 will not interfere with the sheet.

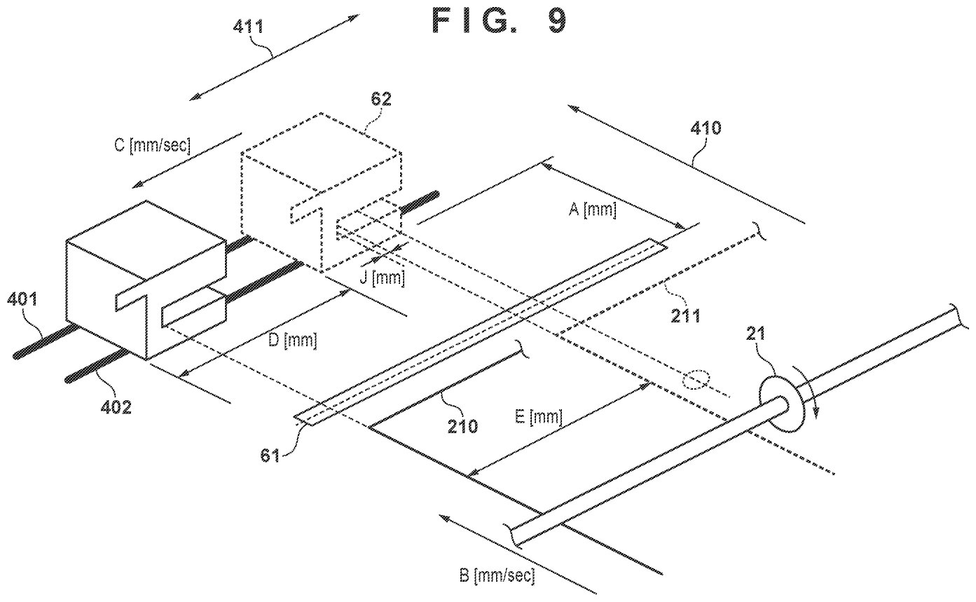

Next, the first threshold value used in step S13 of FIG. 8 is described with reference to FIG. 9. FIG. 9 shows a state in which the leading end of the sheet 210 has reached the detection position of the line sensor 61. Note that reference numeral 211 indicates a sheet in a case where the sheet is being conveyed at the reference conveyance position. As shown in FIG. 9, the punching unit 62 (shown by a dashed line) stands by at the reference standby position. In this example, since the sheet 210 will interfere with the punching unit 62 waiting at the reference standby position the main control unit 101 is made to perform the avoidance process. Here, a distance D [mm] in the width direction in which the punching unit 62 can move from when the line sensor 61 detects the conveyance position of the sheet at the leading end of the sheet 210 to when the leading end of the sheet 210 reaches the position of the punching unit 62 in the conveyance direction is obtained by the following equation.

D=C×(A/B) (1)

Here, A [mm] is a distance from the line sensor 61 to the punching unit 62 in the conveyance direction, B [mm/sec] is a conveyance speed of the sheet 210, and C [mm/sec] is a movement speed of the punching unit 62.

As described with reference to FIG. 3B, the distance between the reference end portion of the sheet 210 being conveyed at the reference conveyance position and the end portion 412 of the punching unit 62 waiting at the reference standby position is J [mm]. Therefore, a maximum value E [mm] of the deviation amount of the sheet 210 at which the punching unit 62 can be prevented from interfering with the sheet 210 by the avoidance process, is obtained by the following equation.

E=D+J (2)

For example, when A=60 [mm], B=400 [mm/sec], and C=60 [mm/sec], D=9 [mm] according to Equation (1). When J=2 [mm], the maximum value E of the deviation amount of the sheet 210 at which the interference can be avoided is 11 [mm] from Equation (2). For example, the sheet processing apparatus 4 can be configured such that a maximum value of an expected deviation amount is less than E.

The first threshold value is set to, for example, a value less than the maximum value E. Note that increasing the threshold value means that the punching process is executed as much as possible and the avoidance process is minimized. However, if the amount of deviation is too large, there is a high possibility that the sheet will not be conveyed normally, and that the sheet will collide with the wall of the conveyance path or the like, and there is a high possibility that the accuracy and quality of the punching will not be maintained even if the punching process is performed in this state. Further, in order to punch the punching target position in the punching unit 62, it is necessary to adjust the position in the width direction of the punching unit 62 standing by at the reference standby position in accordance with the amount of deviation. However, in a case where the amount of deviation is too large, the accuracy of the adjustment of the position of the punching unit 62 in the width direction is lower, and there is a high possibility that the accuracy and quality of the punching will not be maintained. Further, in a case where the amount of deviation is too large, the conveyance position can be changed after the leading end of the sheet 210 passes through the line sensor 61 before reaching the punching unit 62, and in this case, an unintended conveyance failure may occur or a position significantly different from the punching target position may be punched. Therefore, it is preferable to assess the boundary between the amount of deviation at which the accuracy and the quality of the punch can be maintained and the amount of deviation at which the accuracy and the quality of the punch cannot be maintained, and set a value in the vicinity of the boundary to the first threshold value under the condition that it is less than the maximum value E.

As described above, according to the present embodiment, the conveyance position of the sheet is detected by the line sensor 61 on the upstream side of the punching unit 62, and a deviation amount with respect to the reference conveyance position is determined. Then, by comparing the deviation amount with the first threshold value, it is determined whether to perform the punching process or the avoidance process. With this configuration, it is possible to prevent the punching unit 62 from interfering with the sheet.

Note, in the present embodiment, the conveyance position of the sheet is detected by the line sensor 61 of an optical type. However, any other method in which the conveyance position of the sheet can be detected can be used. For example, it is possible to use a configuration, using a photo interrupter moving in the width direction and a sensor flag, in which a conveyance position of the sheet is detected by contact between the sensor flag and the end portion of the sheet. Furthermore, even for an optical type, configuration can be taken so as to detect the sheet conveyance position by moving the sensor itself in the width direction, rather than having fixed light-receiving elements lined up in an array.

### Second Embodiment

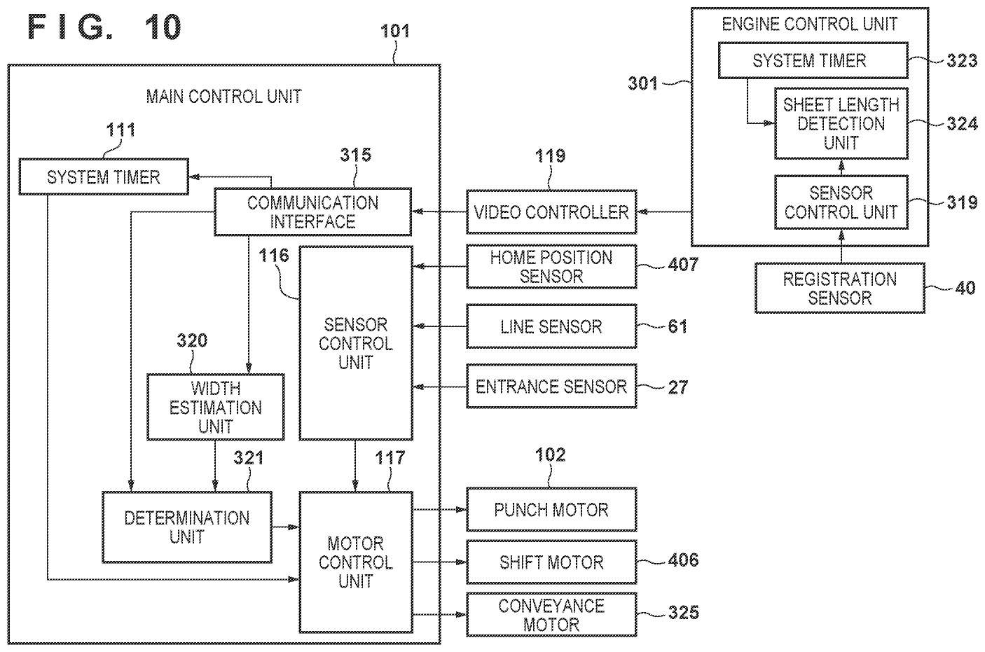

Next, the second embodiment is described with a focus on differences from the first embodiment. FIG. 10 is a block diagram illustrating a functional configuration of the image forming apparatus 1 according to the present embodiment. Note, the same functional blocks as those in the block diagram of the first embodiment shown in FIG. 5 are denoted by the same reference numerals, and the description thereof is omitted. Information indicating the detection state of the sheet obtained by the registration sensor 40 is inputted to a sheet length detection unit 324 of the engine control unit 301 via a sensor control unit 319. The sheet length detection unit 324 uses a system timer 323 to determine the time during which the registration sensor 40 has been detecting the sheet, and determines the sheet length, which is the length in the sheet conveyance direction, based on the time during which the registration sensor 40 has been detecting the sheet and the sheet conveyance speed. The engine control unit 301 notifies information indicating the determined the sheet length (hereinafter, also referred to as “detected sheet length”) to the main control unit 101 of the sheet processing apparatus 4 via the video controller 119.

A width estimation unit 320 of the main control unit 101 obtains information indicating the detected sheet length from the communication interface 315, and estimates the sheet width based on the information. In the following description, the sheet width estimated by the width estimation unit 320 is also referred to as an estimated sheet width. Note, description relating to the estimation of the sheet width is given later. Further, similarly to the first embodiment, the determination unit 321 obtains the size information from the communication interface 315, and determines whether or not the avoidance process is necessary based on the sheet width based on the size information (hereinafter, also referred to as a set sheet width) and the estimated sheet width from the width estimation unit 320. In a case where it is determined that the avoidance process is necessary, the determination unit 321 instructs the motor control unit 117 to execute the avoidance process.

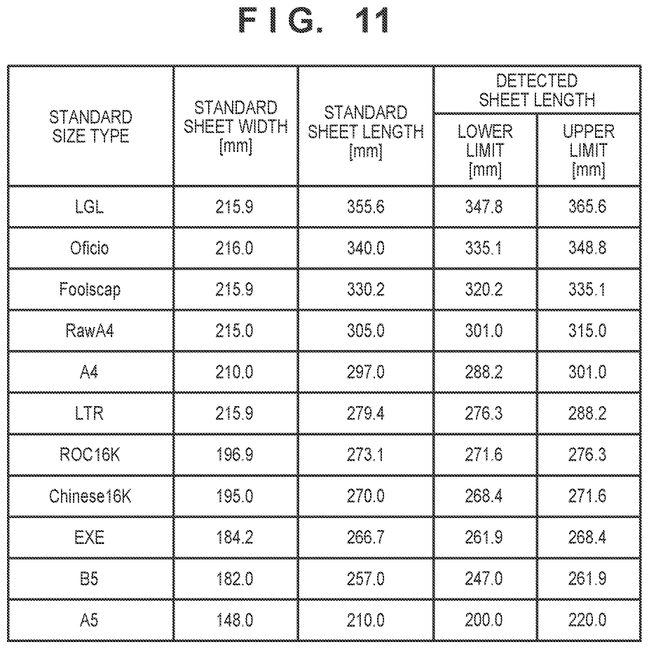

FIG. 11 shows an example of information used when the width estimation unit 320 estimates the sheet width based on the detected sheet length. Note that the information in FIG. 11 is provided for each size of a plurality of sizes of sheets that can be conveyed or used by the image forming apparatus 1. In the table of FIG. 11, a “standard size type” indicates the name of the sheet size defined in a standard, and a “standard sheet width” and a “standard sheet length” indicate the sheet width and the sheet length defined in a standard. The width estimation unit 320 determines whether the detected sheet length is within a range of an “upper limit” and a “lower limit” for any of the records in FIG. 11, and sets the standard sheet width of the determined record as the estimated sheet width. For example, assume that the detected sheet length is 360.2 mm. Here, the width estimation unit 320 determines that 215.9 mm, which is the standard sheet width of an LGL size, is the estimated sheet width because the sheet length is within the range of the lower limit (347.8 mm) and the upper limit (365.6 mm) of an LGL size. Similarly, when the detected sheet length is 300.0 mm, the width estimation unit 320 determines that 210.0 mm, which is the standard sheet width of an A4 size, is the estimated sheet width. Note that, in FIG. 11, a sheet that can be conveyed or used by the image forming apparatus 1 is a sheet of a size defined by a standard, but the present disclosure is not limited to sheets which can be conveyed or used by the image forming apparatus 1 having a size defined by a standard. Specifically, configuration can be taken such that the estimated sheet width is determined by using information indicating a relationship between the detected sheet length and the estimated sheet width for each sheet that can be conveyed or can be used in the image forming apparatus 1 regardless of whether or not the sheet is of a size defined by a standard.

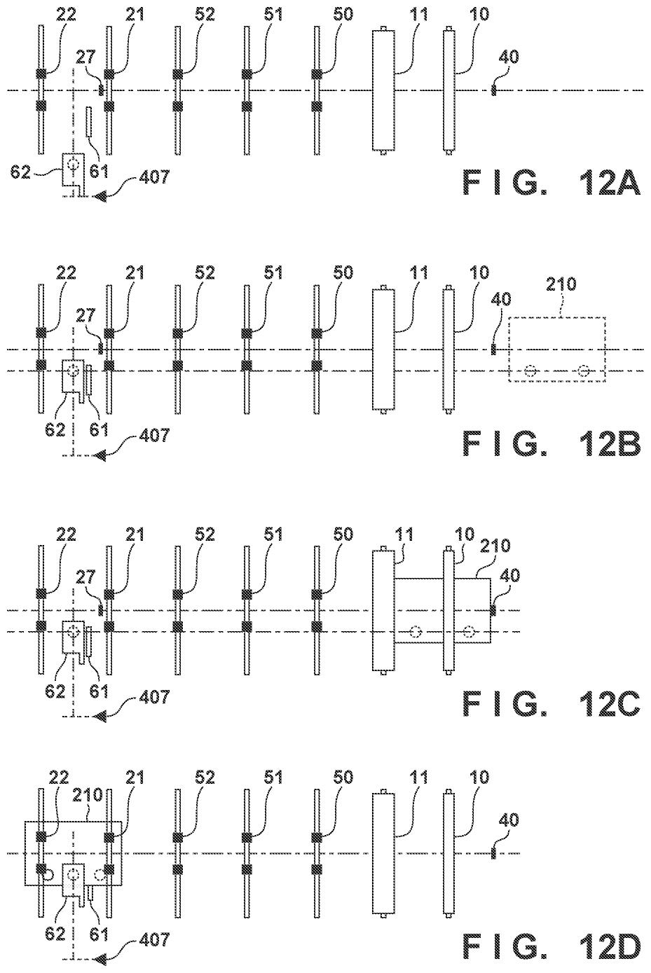

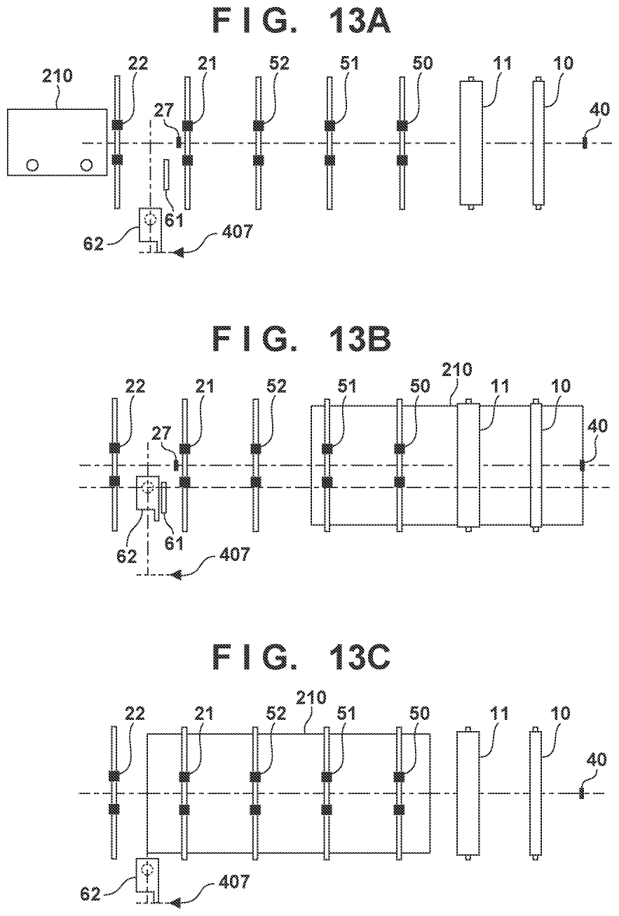

Next, processes performed by the main control unit 101 in the present embodiment are described with reference to FIGS. 12A to 12D and FIGS. 13A to 13C. FIGS. 12A to 12D and FIGS. 13A to 13C show the conveyance path of the sheet from the registration sensor 40 to the exit roller 22. FIG. 12A shows a state before a sheet is conveyed, and the punching unit 62 is standing by at the home position. FIG. 12B shows a state immediately after conveyance of the sheet 210 has started, and the main control unit 101 causes the punching unit 62 to move to the reference standby position based on the size information of the print information obtained from the video controller 119. Note, as in the first embodiment, the reference standby position is determined based on the reference conveyance position, and the reference conveyance position is determined based on the “set sheet width” indicated by the size information or determined based on the size information. FIG. 12C shows a state immediately after the trailing end of the conveyed sheet 210 passes the registration sensor 40. At this timing, the sheet length detection unit 324 detects the sheet length. Note, in this example, it is assumed that the sheet length detected by the sheet length detection unit 324 and the sheet length according to the size information notified by the engine control unit 301 to the main control unit 101 are substantially the same. In this case, the estimated sheet width and the set sheet width are also substantially the same. The determination unit 321 determines that the punching unit 62 will interfere with the sheet 210 when a value of half of the difference between the estimated sheet width and the set sheet width is larger than a second threshold value, and otherwise determines that the punching unit 62 will not interfere with the sheet 210. In this example, since the value of half of the difference between the estimated sheet width and the set sheet width is smaller than the second threshold value, the determination unit 321 determines that the punching unit 62 will not interfere with the sheet 210. Therefore, the determination unit 321 determines to execute the punching process by the punching unit 62.

FIG. 12D shows a state in which the leading end portion of the sheet 210 passes through the punching unit 62, and the punching unit 62 forms one hole in the sheet 210. The solid circle of the sheet 210 indicates where a hole has been punched. FIG. 13A shows a state in which the sheet 210 has passed through the punching unit 62. When the punching of the sheet 210 has completed, the main control unit 101 causes the punching unit 62 to move toward the home position. In this way, in a case where the difference between the estimated sheet width and the set sheet width is small, a normal punching process is performed.

On the other hand, FIG. 13B shows that the size of the sheet 210 differs largely from the size that the engine control unit 301 notified. FIG. 13B shows a state in which the trailing end of the conveyed sheet 210 passes the registration sensor 40. At this timing, the sheet length detection unit 324 detects the sheet length. The width estimation unit 320 determines the estimated sheet width based on the detected sheet length. Note, in this example, it is assumed that the estimated sheet width is larger than the set sheet width, and a value of half of the difference is larger than the second threshold value. In this case, the determination unit 321 determines that the avoidance process is necessary, and instructs the motor control unit 117 to execute the avoidance process.

FIG. 13C shows a state in which the punching unit 62 is retracted to the home position due to the avoidance process. As shown in FIG. 13C, the punching unit 62 does not interfere with the sheet 210, and the sheet 210 is conveyed as it is.

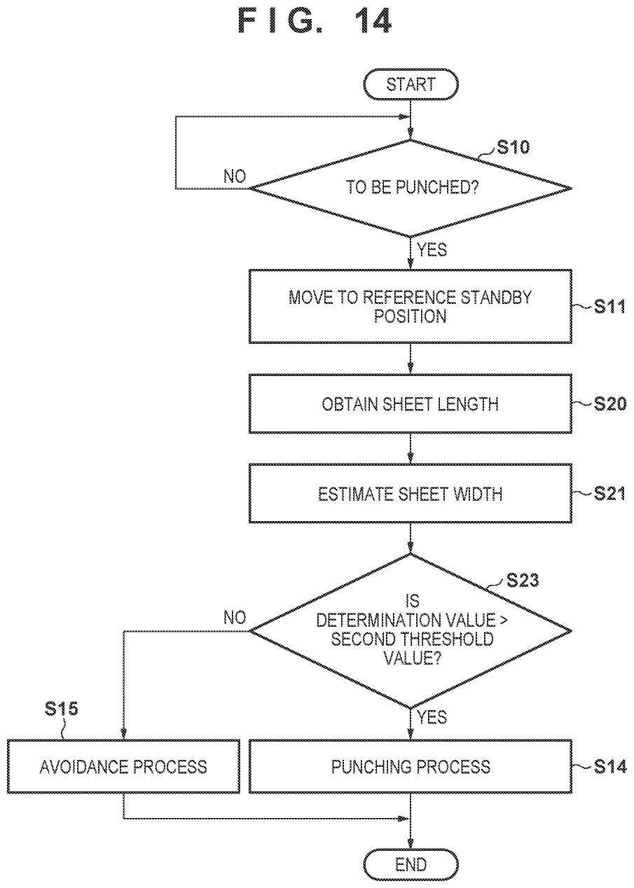

FIG. 14 is a flowchart of a process executed by the main control unit 101 in the present embodiment. Note that at the start of the processing of FIG. 14, the punching unit 62 is standing by at the home position. When the sheet is conveyed, the main control unit 101 in step S10 determines whether or not the sheet is to be punched based on the print information obtained from the video controller 119. If the sheet is not to be punched, the main control unit 101 repeats the processing from step S10. On the other hand, when the sheet is to be punched, the main control unit 101 moves the punching unit 62 to the reference standby position in step S11. Note, the main control unit 101 determines the reference standby position based on the size information included in the print information. Thereafter, the main control unit 101 in step S20 obtains the sheet length detected by the sheet length detection unit 324 from the video controller 119. The main control unit 101 estimates the sheet width based on the sheet length obtained in step S21, that is, determines the estimated sheet width.

In step S23, the main control unit 101 sets a value of half of a difference (width difference) between the estimated sheet width and the set sheet width as a determination value, and compares the determination value with the second threshold value. In a case where the determination value is larger than the second threshold value, the main control unit 101 performs the avoidance process described above in step S15; otherwise, the main control unit 101 executes the punching process by the punching unit 62 in step S14. Note that the determination value in step S23 may be a value that is half of a value obtained by subtracting the set sheet width from the estimated sheet width. That is, configuration may be taken such that, even if the determination value is larger than the second threshold value, in a case where the estimated sheet width is smaller than the set sheet width, the punching process may be performed instead of the avoidance process. This is because, when the estimated sheet width is smaller than the set sheet width, the punching unit 62 and the sheet do not interfere with each other.

Normally, a sheet of the same size as the size notified from the video controller 119 to the main control unit 101 is actually conveyed, and the main control unit 101 executes the punching process based on the notified sheet size. However, a sheet having a size different from the size notified from the video controller 119 may be conveyed. For example, some image forming apparatuses 1 do not have a function for detecting the size of a sheet stored/placed in the cassette 6 or a manual feed tray, not shown in FIG. 1. In such an image forming apparatus 1, when the size of the sheet stored in the cassette 6 or the sheet placed on the manual feed tray is different from the size set in the image forming apparatus 1, the size of the actually conveyed sheet may be different from the notified size.

If the set sheet width, i.e. the sheet width set by the user, differs from the estimated sheet width, i.e. the sheet width determined from the actually detected sheet length, the punching unit 62 may interfere with the sheet. Therefore, the avoidance process is required as in the first embodiment. Note that in the present embodiment, in order to prevent the punching unit 62 from interfering with the sheet, it is necessary to move the punching unit 62 by a distance of ½ of the difference between the set sheet width and the estimated sheet width. That is, compared to moving the punching unit 62 by the deviation amount of sheet conveyance position due to the skewing of the sheet as in the first embodiment, the amount of movement of the punching unit 62 in the avoidance process is much larger.

For example, assuming that sheets of the sizes shown in FIG. 11 are usable in the image forming apparatus 1, the width difference is set to a maximum value of 67.9 mm, when the set sheet width is 148.0 mm corresponding to A5 and the estimated sheet width is 215.9 mm corresponding to LGL. In the present embodiment, the maximum value of the amount of movement of the punching unit 62 is 33.95 mm which is half of the maximum value 67.9 mm of the width difference in this case.

On the other hand, since the deviation amount of the first embodiment is at most about several mm, the amount of movement required to avoid the punching unit 62 is also about several mm. Therefore, after the leading end of the sheet reaches the line sensor 61, it is possible to move the punching unit 62 to a position where it does not interfere with the sheet before the leading end of the sheet reaches the position in the conveyance direction of the punching unit 62.

However, when the amount of movement of the punching unit 62 required for the avoidance process becomes 33.95 mm as in the present embodiment, the avoidance process is too late if the avoidance process is started after the leading end of the sheet reaches the line sensor 61. Therefore, in the present embodiment, it is determined whether or not the avoidance process needs to be executed at a timing earlier than that in the first embodiment, that is, at a timing when the trailing edge of the sheet has passed through the registration sensor 40, and the avoidance process is executed as necessary. Note, in the present embodiment, the necessity of the avoidance process is determined before the sheet is conveyed to the sheet processing apparatus 4, but the present disclosure is not limited to such a configuration. For example, configuration may be taken such that, even if the conveyance distance to the punching unit 62 in the sheet processing apparatus 4 is long and the avoidance process is started after the sheet length is detected in the sheet processing apparatus 4, the sheet length is detected in the sheet processing apparatus 4 as long as the required movement amount can be guaranteed in the punching unit 62. Also, for example, configuration may be taken such that the sheet length is detected by the conveyance sensor 135 after the image is formed on the sheet.

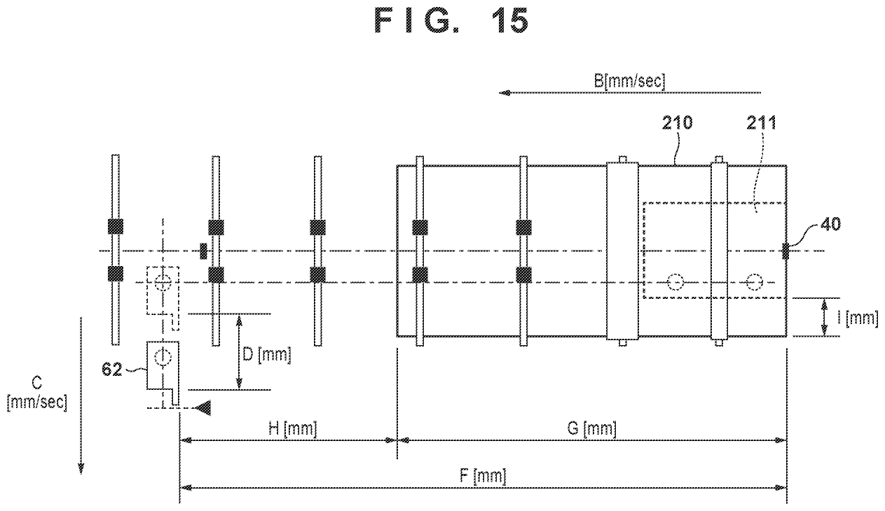

Next, with reference to FIG. 15, the movement distance of the punching unit 62 in the avoidance process of the present embodiment is described. FIG. 15 shows a state in which the trailing end of the actually conveyed sheet 210 has reached the detection position of the registration sensor 40. Note, reference numeral 211 denotes a sheet having a size set by the user in the image forming apparatus 1. As shown in FIG. 15, the punching unit 62 (shown by a dashed line) stands by at the reference standby position. In this example, since the punching unit 62 standing by at the reference standby position would interfere with the sheet 210, the main control unit 101 is made to perform the avoidance process. Here, the distance D [mm] in the width direction in which the punching unit 62 can move after the width estimation unit 320 determines the estimated sheet width based on the detected sheet length until the leading end of the sheet 210 reaches the position in the conveyance direction of the punching unit 62 is obtained by the following equation.

D=C×(H/B) (3)

Here, H [mm] is the distance from the leading end of the sheet 210 to the punching unit 62 when the trailing end of the sheet 210 is at the position of the registration sensor 40, B [mm/sec] is the conveyance speed of the sheet 210, and C [mm/sec] is the movement speed of the punching unit 62.

Note, as shown in FIG. 15, the amount of movement of the punching unit 62 required to avoid the punching unit 62 interfering with the sheet 210 is I [mm]. Therefore, considering the distance J[mm] shown in FIG. 3B, it is possible to avoid the punching unit 62 interfering with the sheet 210 if the following equation is satisfied.

D>I−J (4)

Note, when the distance J is ignored because I>>J in the present embodiment, the punching unit 62 interfering with the sheet 210 can be avoided if the following equation is satisfied.

D>I (5)

For example, assume that a distance F from the registration sensor 40 to the punching unit 62 is 670 [mm], the size set by the user in the image forming apparatus 1 is A5, and an LGL sheet is actually conveyed. In this case, I=33.95 [mm] as described above. In addition, since the length G of an LGL sheet is 355.6 [mm], the distance H is 314.4 [mm]. When B=400 [mm/sec] and C=60 [mm/sec], the distance D becomes 47.16 [mm] according to Equation (3), and since this is larger than the distance I=33.95 [mm], it is possible to avoid the punching unit 62 interfering with the sheet 210.

Note, when the type of sheet shown in FIG. 11 is a sheet that can be conveyed or used by the image forming apparatus 1, the specific values of D [mm] and I [mm] described above are values when the difference between the maximum value and the minimum value of the sheet width is the largest. That is, of the combinations of the set sheets and the sheets actually conveyed, D is the minimum and I is the maximum. If the punching unit 62 interfering with the sheet can be avoided in this combination, it can be avoided in any other combination. Therefore, the second threshold value may be set to a value smaller than the maximum value of I described above, for example.

Note that increasing the second threshold value means that the punching process is executed as much as possible and the avoidance process is kept to a minimum. However, in a case where the determination value (the value of half of the difference of the sheet width) is too large, the accuracy of the adjustment of the position of the punching unit 62 in the width direction will be lower, and there will be a high possibility that the accuracy and quality of the punching will not be maintained. In addition, the determination value being too large means that even when the user has likely set the wrong sheet, the punching process will be executed on the wrong sheet, which is not an operation that the user is thought to desire. Therefore, it is preferable to set an appropriate second threshold value after ascertaining, from the viewpoint of accuracy and quality of the punching and usability, whether the punching process should be determined to be performed or whether the avoidance process should be determined to be performed for the determination value.

As described above, according to the present embodiment, the sheet length is detected on the upstream side of the punching unit 62, and the sheet width is estimated and determined based on the detected sheet length. Then, by comparing determination value, which is half of the difference between the determined or estimated sheet width and the set sheet width, with the second threshold value, it is determined whether the punching process will be performed or the avoidance process will be performed. With this configuration, it is possible to prevent the punching unit 62 from interfering with the sheet. Note that configuration may be taken such that a mechanism for detecting the sheet length is provided on the upstream side of the image forming unit (cartridge 8) that transfers and forms an image on the sheet in the image forming apparatus 1, and the punching unit 62 is provided on the downstream side of the image forming unit 8. By this configuration, it is possible to determine whether the punching process will be performed or the avoidance process will be performed at a timing considerably earlier than the timing at which the sheet reaches the punching position, and it is possible to secure a movement amount of the punching unit 62 larger than that in the first embodiment. Therefore, the avoidance process can be performed even if the size difference between the set sheet and the actually conveyed sheet is large.

Note, in the present embodiment, the value of half of the difference between the set sheet width and the estimated sheet width is compared with the second threshold, but configuration may be taken such that the difference between the set sheet width and the estimated sheet width is compared with the second threshold. Furthermore, in the present embodiment, the description has been made based on the sheet width, but the description can be made in terms of the conveyance position as in the first embodiment. Specifically, the main control unit 101 determines the set sheet width based on the size information obtained from the video controller 119, and determines the reference conveyance position based on the set sheet width. Subsequently, when the estimated sheet width is determined based on the sheet length detected by the sheet length detection unit 324, the main control unit 101 determines the conveyance position based on the estimated sheet width. Note, the conveyance position based on the estimated sheet width is determined based on the same criteria as the reference conveyance position based on the set sheet width. In this case, the difference between the conveyance position and the reference conveyance position based on the estimated sheet width corresponds to a value of half of the difference between the set sheet width and the estimated sheet width, that is, the determination value described above.

Note that in the present embodiment, the sheet length is detected by the registration sensor 40 included in the normal image forming apparatus 1, the estimated sheet width is determined based on the detected sheet length, and the conveyance position of the sheet is determined based on the estimated sheet width. However, as in the first embodiment, configuration may be taken such that the conveyance position of the conveyed sheet, that is, the position of the reference end portion of the conveyed sheet in the width direction is directly detected.

### OTHER EMBODIMENTS

Note that configuration may be taken such that the image forming apparatus 1 selectively performs the processing of the first embodiment and the processing of the second embodiment. Furthermore, configuration may be taken such that the image forming apparatus 1 performs both the processing of the first embodiment and the processing of the second embodiment. In this case, for example, a first detection unit that detects the conveyance position of the sheet is provided on the downstream side of the conveyance path from a second detection unit that detects the sheet length. Note, in the above-described embodiment, the first detection unit corresponds to the line sensor 61, and the second detection unit corresponds to the registration sensor 40. Also, the punching unit 62 for punching the sheet is provided on the downstream side of the conveyance path from the first detection unit. Note that configuration may be taken such that the second detection unit that detects the sheet length is provided on the upstream side of the image forming unit that forms an image on the sheet. The image forming unit corresponds to the cartridge 8 of the above-described embodiment. Configuration may be taken such that the second detection unit that detects the sheet length is provided on the downstream side of the image forming unit that forms an image on the sheet.

Further, in each of the above-described embodiments, the movement direction of the punching unit 62 is the width direction. However, as long as the position of the punching unit 62 in the width direction can be changed, the moving direction of the punching unit 62 is not limited to the width direction. For example, configuration may be taken such that the punching unit 62 is moved in a direction that is not parallel to the conveyance direction in a plane parallel to the sheet surface. Further, configuration may also be taken such that the movement direction of the punching unit 62 is not in a plane parallel to the sheet surface. That is, the moving direction of the punching unit 62 may be a direction intersecting the conveyance direction of the sheet.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-205469, filed Dec. 17, 2021, which is hereby incorporated by reference herein in its entirety.

What is claimed is:

1. A sheet processing apparatus, comprising:
a conveyance unit configured to convey a sheet along a conveyance path;
a punching unit configured to punch the sheet conveyed by the conveyance unit;
a movement unit configured to cause the punching unit to move in a direction intersecting with a conveyance direction of the sheet;
a detection unit arranged on an upstream side of the conveyance path with reference to the punching unit, and configured to detect a first conveyance position which is a position in a width direction orthogonal to the conveyance direction of the sheet conveyed by the conveyance unit; and
a control unit configured to obtain size information of the sheet, determine, based on the size information, a second conveyance position which is a position in the width direction when the sheet is conveyed by the conveyance unit, and by comparing the first conveyance position and the second conveyance position, control whether or not to execute an avoidance process that causes the punching unit to move away from the sheet.

2. The sheet processing apparatus according to claim 1, wherein
the detection unit is configured to detect, as the first conveyance position, a position in the width direction of a first end portion which is one of two end portions of the sheet in the width direction, and
the control unit is configured to determine, based on a size indicated by the size information, as the second conveyance position, a position in the width direction of the first end portion when the sheet is conveyed by the conveyance unit.

3. The sheet processing apparatus according to claim 1, wherein
the control unit is configured to execute the avoidance process in a case where a difference between the first conveyance position and the second conveyance position is larger than a threshold value.

4. The sheet processing apparatus according to claim 3, wherein
the threshold value is smaller than a value obtained by adding a predetermined value to a distance in the width direction that the movement unit can cause the punching unit to move while the sheet is conveyed from a position in the conveyance direction along which the detection unit detects the first conveyance position to a position in the conveyance direction where the punching unit punches the sheet.

5. A sheet processing apparatus, comprising:
a conveyance unit configured to convey a sheet along a conveyance path;
a punching unit configured to punch the sheet conveyed by the conveyance unit;
a movement unit configured to cause the punching unit to move in a direction intersecting with a conveyance direction of the sheet;
a detection unit arranged on an upstream side of the conveyance path with reference to the punching unit, and configured to detect a sheet length which is a length in the conveyance direction of the sheet conveyed by the conveyance unit; and
a control unit configured to determine a first conveyance position which is a position in a width direction orthogonal to the conveyance direction when the sheet of the sheet length is conveyed by the conveyance unit, obtain size information of the sheet, determine, based on the size information, a second conveyance position which is a position in the width direction when the sheet is conveyed by the conveyance unit, and by comparing the first conveyance position and the second conveyance position, control whether or not to execute an avoidance process that causes the punching unit to move away from the sheet.

6. The sheet processing apparatus according to claim 5, wherein
the control unit is configured to determine, based on a size determined from the sheet length, as the first conveyance position, a position in the width direction of a first end portion which is one of two end portions of the sheet when the sheet is conveyed by the conveyance unit, and determine, based on a size indicated by the size information, as the second conveyance position, a position in the width direction of the first end portion when the sheet is conveyed by the conveyance unit.

7. The sheet processing apparatus according to claim 5, wherein
the control unit is configured to execute the avoidance process in a case where a difference between the first conveyance position and the second conveyance position is larger than a threshold value.

8. The sheet processing apparatus according to claim 7, wherein
the threshold value is smaller than half of a difference between a maximum value and a minimum value of a length in the width direction of sheets of a plurality of sizes that are usable in the sheet processing apparatus.

9. The sheet processing apparatus according to claim 1, wherein
a timing at which the first conveyance position is detected is a timing that comes after a timing at which the control unit determines the second conveyance position.

10. The sheet processing apparatus according to claim 1, wherein
the control unit is configured to, when the control unit determines the second conveyance position, cause the punching unit to move from a home position to a standby position that corresponds to the second conveyance position, and
the standby position is a position closer to the conveyance path than the home position.

11. The sheet processing apparatus according to claim 10, wherein the control unit is configured to, when the control unit executes the avoidance process, cause the punching unit to move from the standby position to the home position.

12. The sheet processing apparatus according to claim 1, wherein
the control unit is configured to, in a case where the control unit does not execute the avoidance process, cause the punching unit to punch the sheet.

13. A sheet processing apparatus, comprising:
a conveyance unit configured to convey a sheet along a conveyance path;
a punching unit configured to punch the sheet conveyed by the conveyance unit;
a movement unit configured to cause the punching unit to move in a direction intersecting with a conveyance direction of the sheet;
a detection unit arranged on an upstream side of the conveyance path with reference to the punching unit, and configured to detect a sheet length which is a length in the conveyance direction of the sheet conveyed by the conveyance unit; and
a control unit configured to obtain size information relating to a first sheet width which is a length of the sheet in a width direction orthogonal to the conveyance direction, determine, based on the sheet length, a second sheet width which is a length of the sheet in the width direction, and by comparing the first sheet width and the second sheet width, control whether or not to execute an avoidance process that causes the punching unit to move away from the sheet.

14. The sheet processing apparatus according to claim 1, wherein the size information is information set by a user or information received from an external apparatus of the sheet processing apparatus.

15. A sheet processing apparatus, comprising:
a conveyance unit configured to convey a sheet along a conveyance path;
a punching unit configured to punch the sheet conveyed by the conveyance unit;
a movement unit configured to cause the punching unit to move in a direction intersecting with a conveyance direction of the sheet;
a first detection unit arranged on an upstream side of the conveyance path with reference to the punching unit, and configured to detect a first conveyance position which is a position in a width direction orthogonal to the conveyance direction of the sheet conveyed by the conveyance unit;
a second detection unit arranged on an upstream side of the conveyance path with reference to the punching unit, and configured to detect a sheet length which is a length in the conveyance direction of the sheet conveyed by the conveyance unit; and
a control unit configured to obtain information relating to a first sheet width which is a length of the sheet in the width direction, determine, based on the first sheet width, a second conveyance position which is a position in the width direction when the sheet is conveyed by the conveyance unit, determine, based on the sheet length, a second sheet width which is a length of the sheet in the width direction, and in order to control whether or not to execute an avoidance process which causes the punching unit to move away from the sheet, execute a comparison between the first sheet width and the second sheet width and a comparison between the first conveyance position and the second conveyance position.

16. The sheet processing apparatus according to claim 15, wherein the control unit is configured to execute the avoidance process in a case where a difference between the first conveyance position and the second conveyance position is larger than a first threshold value or in a case where a difference between the first sheet width and the second sheet width is larger than a second threshold value.

17. The sheet processing apparatus according to claim 15, wherein a timing at which the first detection unit detects the first conveyance position is after a timing at which the second detection unit detects the sheet length.

18. The sheet processing apparatus according to claim 17, wherein a timing at which the control unit obtains the information relating to the first sheet width is before a timing at which the second detection unit detects the sheet length.

19. The sheet processing apparatus according to claim 15, wherein
the control unit is configured to, when the control unit determines the second conveyance position, cause the punching unit to move from a home position to a standby position which corresponds to the second conveyance position, and
the standby position is a position closer to the conveyance path than the home position.

20. An image forming apparatus, comprising:
a conveyance unit configured to convey a sheet along a conveyance path;
an image forming unit configured to form an image on the sheet conveyed by the conveyance unit;
a punching unit configured to punch the sheet conveyed by the conveyance unit;
a movement unit configured to cause the punching unit to move in a direction intersecting with a conveyance direction of the sheet;
a detection unit arranged on an upstream side of the conveyance path with reference to the punching unit, and configured to detect a first conveyance position which is a position in a width direction orthogonal to the conveyance direction of the sheet conveyed by the conveyance unit; and
a control unit configured to obtain size information of the sheet, determine, based on the size information, a second conveyance position which is a position in the width direction when the sheet is conveyed by the conveyance unit, and by comparing the first conveyance position and the second conveyance position, control whether or not to execute an avoidance process that causes the punching unit to move away from the sheet.

21. The image forming apparatus according to claim 20, wherein
the detection unit and the punching unit are arranged on a downstream side of the conveyance path with reference to the image forming unit.

22. An image forming apparatus, comprising:
a conveyance unit configured to convey a sheet along a conveyance path;
an image forming unit configured to form an image on the sheet conveyed by the conveyance unit;
a punching unit configured to punch the sheet conveyed by the conveyance unit;
a movement unit configured to cause the punching unit to move in a direction intersecting with a conveyance direction of the sheet;
a detection unit arranged on an upstream side of the conveyance path with reference to the punching unit, and configured to detect a sheet length which is a length in the conveyance direction of the sheet conveyed by the conveyance unit; and
a control unit configured to determine a first conveyance position which is a position in a width direction orthogonal to the conveyance direction when the sheet of the sheet length is conveyed by the conveyance unit, obtain size information of the sheet, determine, based on the size information, a second conveyance position which is a position in the width direction when the sheet is conveyed by the conveyance unit, and by comparing the first conveyance position and the second conveyance position, control whether or not to execute an avoidance process that causes the punching unit to move away from the sheet.

23. The image forming apparatus according to claim 22, wherein
the detection unit is arranged on an upstream side of the conveyance path with reference to the image forming unit, and
the punching unit is arranged on a downstream side of the conveyance path with reference to the image forming unit.

24. An image forming apparatus, comprising:
a conveyance unit configured to convey a sheet along a conveyance path;
an image forming unit configured to form an image on the sheet conveyed by the conveyance unit;
a punching unit configured to punch the sheet conveyed by the conveyance unit;
a movement unit configured to cause the punching unit to move in a direction intersecting with a conveyance direction of the sheet;
a first detection unit arranged on an upstream side of the conveyance path with reference to the punching unit, and configured to detect a first conveyance position which is a position in the width direction orthogonal to the conveyance direction of the sheet conveyed by the conveyance unit;
a second detection unit arranged on an upstream side of the conveyance path with reference to the punching unit, and configured to detect a sheet length which is a length in the conveyance direction of the sheet conveyed by the conveyance unit; and
a control unit configured to obtain information relating to a first sheet width which is a length of the sheet in the width direction, determine, based on the first sheet width, a second conveyance position which is a position in the width direction when the sheet is conveyed by the conveyance unit, determine, based on the sheet length, a second sheet width which is a length of the sheet in the width direction, and in order to control whether or not to execute an avoidance process which causes the punching unit to move away from the sheet, execute a comparison between the first sheet width and the second sheet width and a comparison between the first conveyance position and the second conveyance position.

25. The image forming apparatus according to claim 24, wherein
the second detection unit is arranged on an upstream side of the conveyance path with reference to the image forming unit, and
the first detection unit and the punching unit are arranged on a downstream side of the conveyance path with reference to the image forming unit.
